(19) United States
(12) Patent Application Publication
(10) Pub. No.: US 2007/0220560 A1
(43) Pub. Date: Sep. 20, 2007

(54) Audio/video transmission system and method

(75) Inventor: William T. Devine III, Freedom, NH (US)

Correspondence Address: SCOTT C. RAND, ESQ.;MCLANE, GRAF, RAULERSON & MIDDLETON, PA, 900 ELM STREET, P.O. BOX 326, MANCHESTER, NH, 03105-0326, US

(73) Assignee: Audioplex Technology Incorporated, Melvin Village, NH (US)

(21) Appl. No.: 11/374,880

(22) Filed: Mar. 14, 2006

(51) Int. Cl. H04N 7/18

(52) U.S. Cl. 725/78

(57) ABSTRACT

An audio/video signal distribution system includes a wall plate transmitter and wall plate receiver, which communication via twisted pair cabling. In a further aspect, a method of distributing an audio/video signal is provided.

### BACKGROUND

The present disclosure relates to audio/video signal distribution and more particularly to a system and method for transmitting an audio/video signal over twisted pair cable.

In order to increase the flexibility of audio/video systems, such as a home entertainment systems and others, a number of distribution systems have been developed wherein a media source in one room can be transmitted to other rooms or locations on the premises. So-called structured wiring systems have become increasingly popular and may commonly include unshielded twisted pair cables (e.g., Category 5 or better) for telephone and data/networking and coaxial cables (e.g., RG6 cables) for video. Additional cabling may also be included, such as speaker cable (e.g., 4/14 or 4/16 cable) to carry audio signals to speakers. Often, all wiring is routed back to a hub panel, where connections are made to each room.

It is also known to distribute audio/video signals over twisted pair cable, such as Category 5 or the like. However, such systems typically require that the audio/video source use be connected to a separate circuit-carrying enclosure or unit, which in turn is connected to the twisted pair cable run via a cable having a modular plug such as a RJ-45 connector at each end, which plugs into the external enclosure and into a wall plate connector having modular socket (e.g., female RJ-45 connector). Similarly, a second separate circuit-carrying enclosure or unit is typically used between the end of the twisted pair cable run proximate the receiving component. Again, a cable with a modular connector at each end is used to connect the second enclosure to the modular wall outlet.

It has been found that such RJ-45 junctions are a source of a number of problems, such as noise, impedance problems, and cross talk. Accordingly, what is needed is an apparatus and method for transmitting an audio/visual signal which eliminate the need for any external circuit carrying enclosures or modular (e.g., RJ-45 type) connectors.

### SUMMARY

In accordance with exemplary embodiments of the present invention, a system for distributing an audio/video signal from an audio/video source to an audio/video receiver, includes a transmitter assembly including a first wall plate, a source audio/video connector adapted to be coupled to an output of the audio/video source, and a first circuit board attached to the first wall plate. The first circuit board includes a first signal processor in communication with the source audio/video connector and a first plurality of terminals in communication with the first signal processor. A receiver assembly includes a second wall plate, a receiver audio/video connector adapted to be coupled to the audio/video receiver, and a second circuit board attached to the second wall plate. The second circuit board includes a second signal processor in communication with the receiver audio/video connector and a second plurality of terminals in communication with the second signal processor. A twisted pair cable having a first end and a second end includes one or more twisted pairs of conductors. Each terminal of the first plurality of terminals is adapted to be connected to an individual conductor of the one or more twisted pairs of conductors at the first end of the cable and each terminal of the second plurality of terminals is adapted to be connected to an individual conductor of the one or more twisted pairs of conductors at the second end of the cable.

In further exemplary embodiments, a method for distributing an audio/video signal from an audio/video source to an audio/video receiver, includes connecting the output of an audio/video source to a wall-mounted transmitter assembly, the transmitter assembly including a source audio/video connector, a wall plate connected to a electrical wall box, and a first circuit board received within the electrical wall box, the first circuit board including a first signal processor in communication with the source audio/video connector and a first plurality of terminals in communication with the first signal processor. The input of an audio/video receiver is connected to a wall-mounted receiver assembly, the receiver assembly including a receiver audio/video connector, a wall plate attached to an electrical wall box, and a second circuit board attached to the wall plate, the second circuit board including a second signal processor in communication with the receiver audio/video connector and a second plurality of terminals in communication with the second signal processor. A first conductor is connected to one of the first plurality of terminals and to one of the second plurality of terminals, and a second conductor is connected to another of the first plurality of terminals and to another of the second plurality of terminals, the first and second conductors being individual conductors of a twisted pair of conductors of a twisted pair cable extending between the wall plate transmitter and the wall plate receiver.

In still further exemplary embodiments a kit having component parts capable of being packaged in a disassembled or partially disassembled form and of being assembled into a system adapted for distributing an audio/video signal from an audio/video source to an audio/video receiver, includes a transmitter assembly including a first wall plate, a source audio/video connector adapted to be coupled to an output of the audio/video source, and a first circuit board attached to the first wall plate. The first circuit board includes a first signal processor in communication with the source audio/video connector and a first plurality of terminals in communication with the first signal processor. A receiver assembly includes a second wall plate, a receiver audio/video connector adapted to be coupled to the audio/video receiver, and a second circuit board attached to the second wall plate. The second circuit board includes a second signal processor in communication with the receiver audio/video connector and a second plurality of terminals in communication with the second signal processor. Each terminal of the first and second plurality of terminals is adapted to connect an individual conductor of a twisted pair cable.

Additional features will be apparent from the following detailed description and drawings, which illustrate exemplary embodiments of the invention.

### BRIEF DESCRIPTION OF THE DRAWINGS

The invention may take form in various components and arrangements of components, and in various steps and arrangements of steps. The drawings are only for purposes of illustrating preferred embodiments and are not to be construed as limiting the invention.

FIG. 1 is a block diagram illustrating an audio/video transmission system in accordance with an exemplary embodiment of the present invention.

FIGS. 2A-2D illustrate several power supply schemes.

FIGS. 3-18 illustrate some of the preferred wall plate connector configurations.

FIG. 19 is a somewhat schematic side view of the embodiment shown in FIG. 11.

FIG. 20 shows a typical application of the embodiment shown in FIG. 11.

FIG. 21 illustrates an exemplary embodiment of the present invention which incorporates an optical repeater system.

FIG. 22 illustrates the embodiment of FIG. 18, showing an exemplary bezel about the wall plate units.

### DETAILED DESCRIPTION OF THE PREFERRED EMBODIMENTS

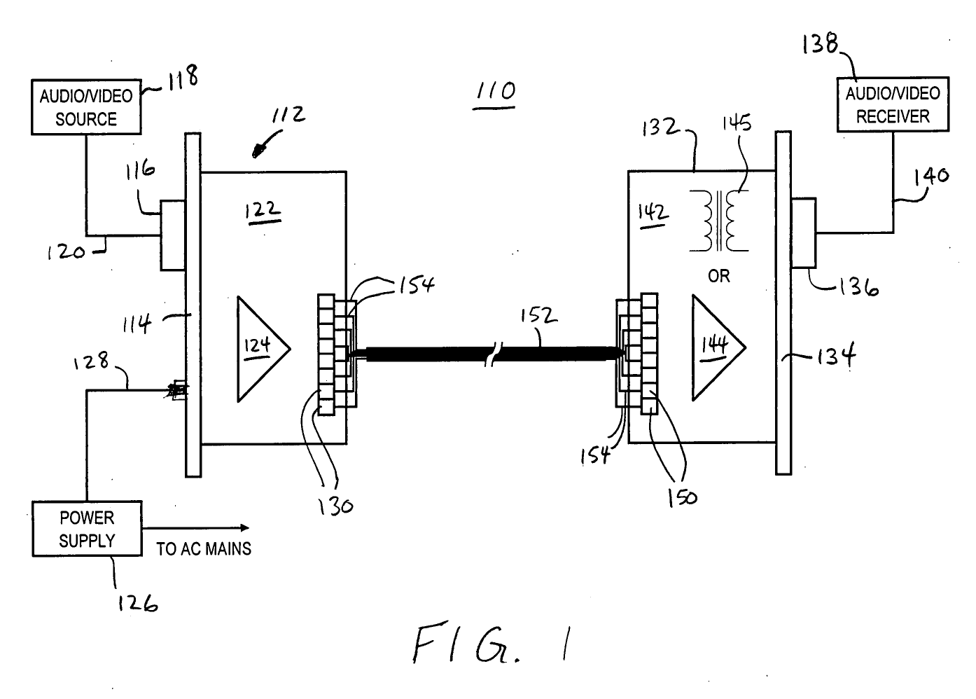

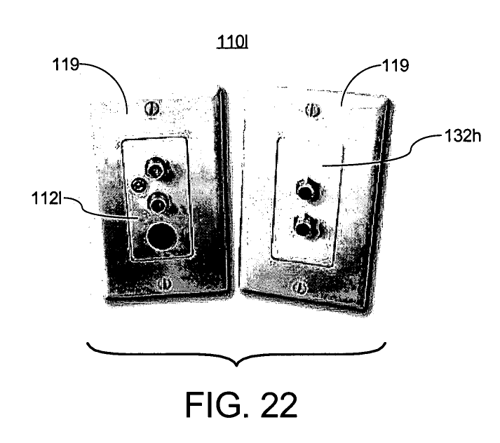

Referring now to the drawings, FIG. 1 illustrates an audio/video transmission system 110 according to an exemplary embodiment of the present invention. As used herein, the term “audio/video” means audio and/or video, that is, audio only, video only, or both audio and video. The system 110 includes a transmitter wall plate unit 112 and a receiver wall plate unit 132. The transmitting and receiving units 112 and 132 each include a plate or panel 114 and 134, respectively, adapted to be mounted over an opening in a wall through which the transmitting and receiving units are received. For example, the wall plate members 114, 134 may include openings 117 (see FIG. 3) for receiving threaded fasteners for securing the respective plate member 114, 134 to an electrical wall box received in the wall where the unit is to be mounted and/or for attaching a bezel, frame, or faceplate 119 (see FIG. 22) to the wall plate members to cover the edge of the wall opening and/or to otherwise give a desired finished appearance.

A plurality of transmit and/or receive wall plate units may be employed. For example, due to size constraints, a desired number of connectors 116 or 136 cannot be accommodated on a single transmit or receive, respectively. In such cases, the desired connectors can be placed on multiple wall plate units, which may be mounted side-by-side in a multiple-gang electrical wall box. Also, the placement of connectors on multiple plates can increase the modularity of the system and allow greater flexibility in accommodating a wide variety of audio/video source and receiver configurations.

Although the present invention is described herein primarily by way of reference to the presently preferred embodiments wherein a source audio/video signal is transmitted to a single remote location, it will be recognized that the present invention may be readily adapted for to transmit the audio/video signal to multiple remote locations, e.g., to distribute the transmitted audio/video signal to allow listening and/or viewing in multiple rooms or locations in a house or premises.

One or more twisted pair cables 152 provide electrical communication between the units 112 and 132. The twisted pair cable 152 is preferably Category 5 (CAT5) or better (e.g., CAT5e, CAT6, etc.) unshielded twisted pair (UTP) cable, although other cable categories are also contemplated, e.g., CAT4, CAT7, and so forth.

One or more audio/video connectors 116 are mounted on the exterior-facing surface of the wall plate member 114. The connector(s) 116 may include any one or more connectors for receiving an analog or digital audio/video signal from an audio/video source component 118. The connectors 116 allow the media source 118 to be connected directly to the wall plate unit 112 via a conventional audio/video cable 120 having a mating connector(s) thereon, without the need for a separate circuit-carrying enclosure and without the need for a modular or crimped on RJ-type connector in the signal path.

The audio/video source 118 may be any audio and/or video media source, including without limitation a portable or component music and/or video player, home theater or entertainment system, an audio amplifier, radio receiver, a centralized audio/video system including whole house audio/video equipment, video receiver including television receiver, camera, camcorder, television set top box, multimedia computer, or other analog or digital video source including cable or satellite television source, which may be a separate video (S-Video) signal, composite video signal, component video signal (including RGB and others such as YUV, YCbCr, YPbPr and YIQ), and so forth.

The cable 120 may be any suitable cable for coupling an output of the audio/video source 118 directly to the connector(s) 116. Without limitation, the one or more connectors 116 may be one or more of RCA-type phono connectors, S-Video connectors, phone plug jacks, including tip-sleeve (TS), tip-ring-sleeve (TRS), or tip-ring-ring-sleeve (TRRS) phone jacks, XLR connectors, RF (e.g., coaxial) connectors, optical fiber connectors, and the like. In preferred embodiments, the system may employ mono or stereo phone plug jacks for analog audio (e.g., 2.5 mm or 3/32″, 3.5 mm or ⅛″, or 6.3 mm or ¼″ phone jacks); RCA-type phono jacks for analog or digital (e.g., S/PDIF) audio and/or analog video (composite or component video); mini-DIN plug for S-video; TOSLINK (TM) optical connectors (including without limitation JIS F05 connectors among others) for digital audio streams, digital video connectors such as IEEE 1394 (FireWire), Digital Visual Interface (DVI), or High-Definition Multimedia Interface (HDMI) connectors, and so forth.

Connector(s) 136 on the receiving wall plate unit 132 may be of the types as described above by way of reference to the connectors 116. A conventional audio/video cable 140 is used to connect the connector(s) 136 to an audio/video receiver 138. The audio/video receiver 138 may be any audio/video equipment capable of receiving an audio/video signal from the audio/video source 118, including without limitation a home theater or entertainment system, an audio amplifier, a centralized audio/video system including whole house audio/video equipment, video receiver including a digital or analog television, television receiver or monitor, television set top box, camera, camcorder, or other analog or digital video receiver.

In this manner, the cables 120 and 140 are used to connect the audio/video source 118 and audio/video receiver 138 directly to the wall plate units 112 and 132, respectively, thereby avoiding the need to provide a separate unit or enclosure to couple the equipment (118, 138) to the twisted pair cable 152. Also, since the connectors 120, 140 may be of the conventional cable type for connecting the respective audio/video equipment 118 and 138, the present embodiments thereby avoid the need to use an RJ-type of connector in the signal path.

A circuit board 122 is attached to the plate member 114 on the interior-facing side thereof and is sized to be received within the wall opening or electrical wall box. A circuit board 142 is attached to the interior side of the plate member 134 in like manner. The circuit boards may be attached to the respective panels via threaded fasteners, brackets, clips, tabs, mounting bosses, or the like. The connector(s) 116 and 136 may be coupled to the respective circuit board 122 or 142 via a number of methods. The connectors (116, 136) may be rigidly secured to the corresponding circuit board (122, 142) at a position so as to extend through complimentary aligned openings in the panel members 114, 134, respectively, and/or may be fastened directly to, (e.g., within openings formed in), the panel members 114, 134, respectively.

Signal processing circuitry 124, such as an amplifier 124 is mounted on the circuit board 122 and is electrically coupled to the connector(s) 116, e.g., via printed or etched conductive pathways on the circuit board 122. In preferred embodiments, the amplifier 124 is a differential amplifier which converts an incoming unbalanced audio/video signal, e.g., a line level signal, to a balanced audio/video signal. The output of the amplifier 124 is passed to the twisted pair cable 152 via an array of contacts 130. The contacts 130 may be terminal blocks or strips, barrier strips, and so forth (including solder and solderless types), bond or contact pads, and so forth, for connection to the individual conductors of the cable 152. The contacts 130 are electrically coupled to the outputs of the amplifier 124, e.g., via printed conductive pathways on the circuit board. Preferably, the terminal contacts 130 are screw-type terminals.

In the depicted embodiment, the twisted pair cable 152 includes eight conductors, that is, four twisted pairs, received within a common sheath. It will be recognized that the number of contacts 130 needed will depend on the number and type of connector(s) 116 present and whether power is being supplied over the cable 152. Thus, the number of connectors may be fewer or greater than eight. In the case of CAT5 or better UTP cable the number of conductors needed to transmit the audio/video signal(s) (and optionally power) may be fewer than eight, in which case all four twisted pairs are not used. Likewise, where more than eight conductors are required, additional contacts 130 may be provided and cables 152 will be needed.

Contacts 150, which may be the same as the contacts 130, are provided on the circuit board 142 of the receiving unit 132 to electronically couple the cable 152 conductors to the onboard signal processing circuitry which may include an amplifier 144 (or alternatively an audio/video transformer 145).

The amplifier 124 is coupled to a power supply 126, which is preferably a “wall wart” style power adapter or transformer which may be connected to the AC power supply of the premises, e.g., via a wall outlet 127 (see FIG. 20). The power supply 126 may be electrically connected to the amplifying circuitry 124 via conductive wiring or cable 128 (see FIG. 20) which may terminate in a connector 125 (see FIG. 20) which mates with a complimentary connector 129 on the plate member 114 (see, e.g., FIG. 4).

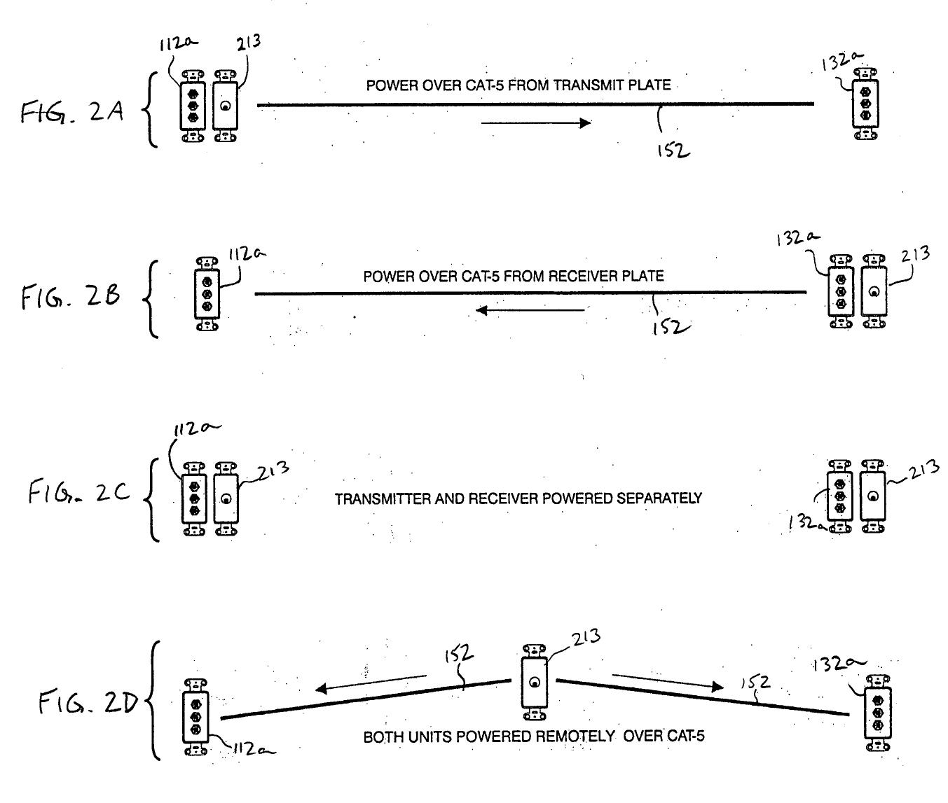

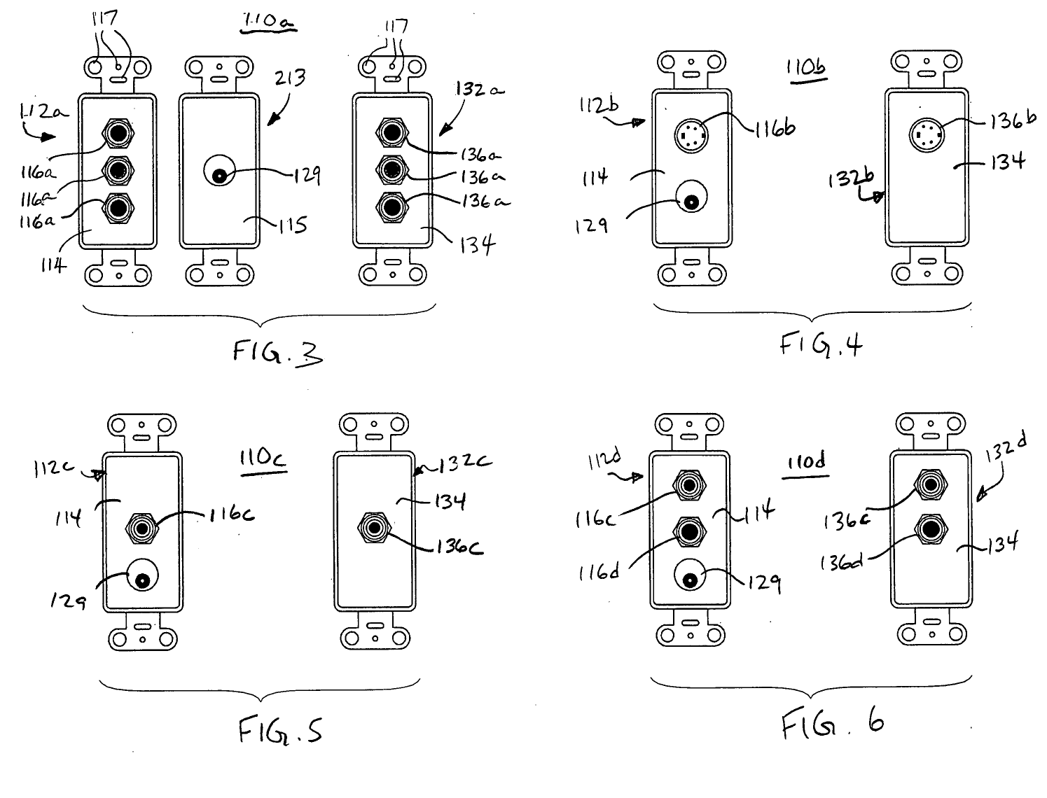

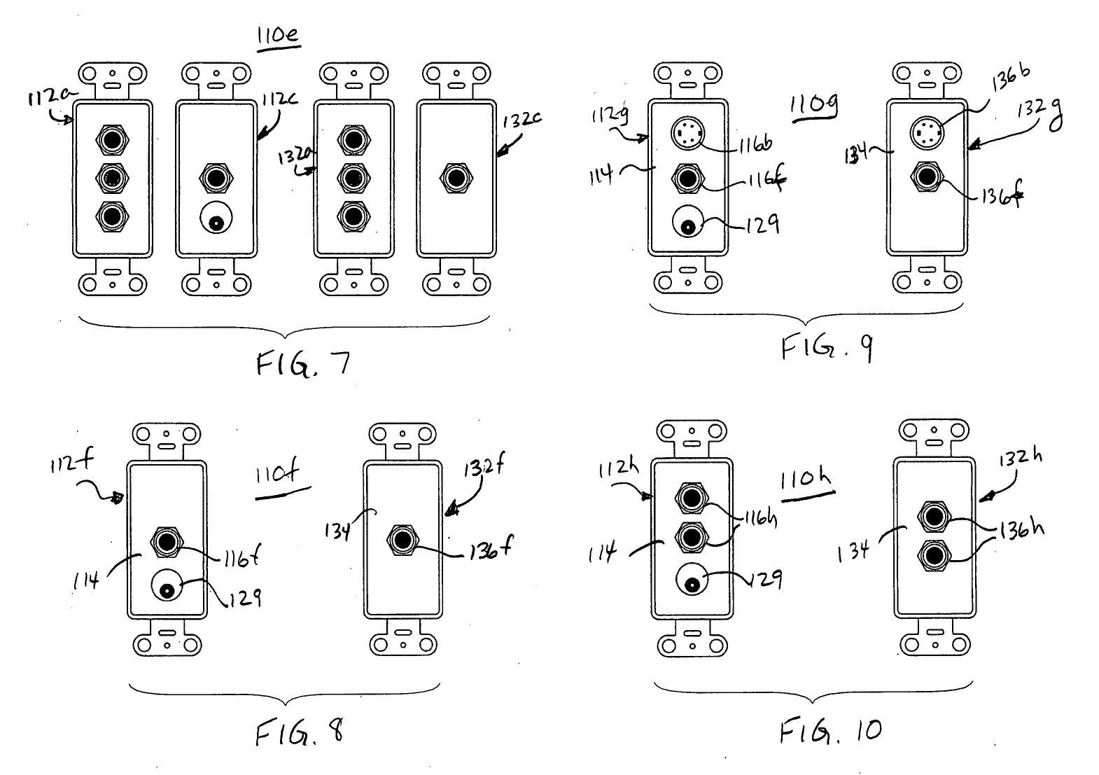

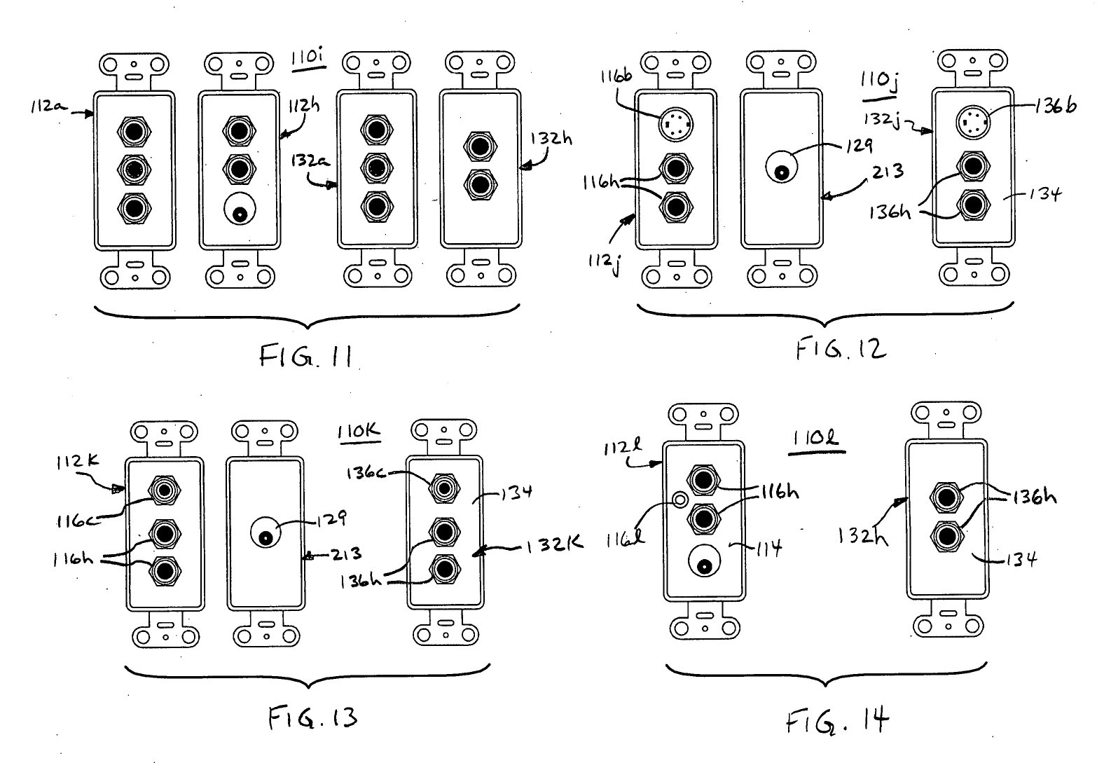

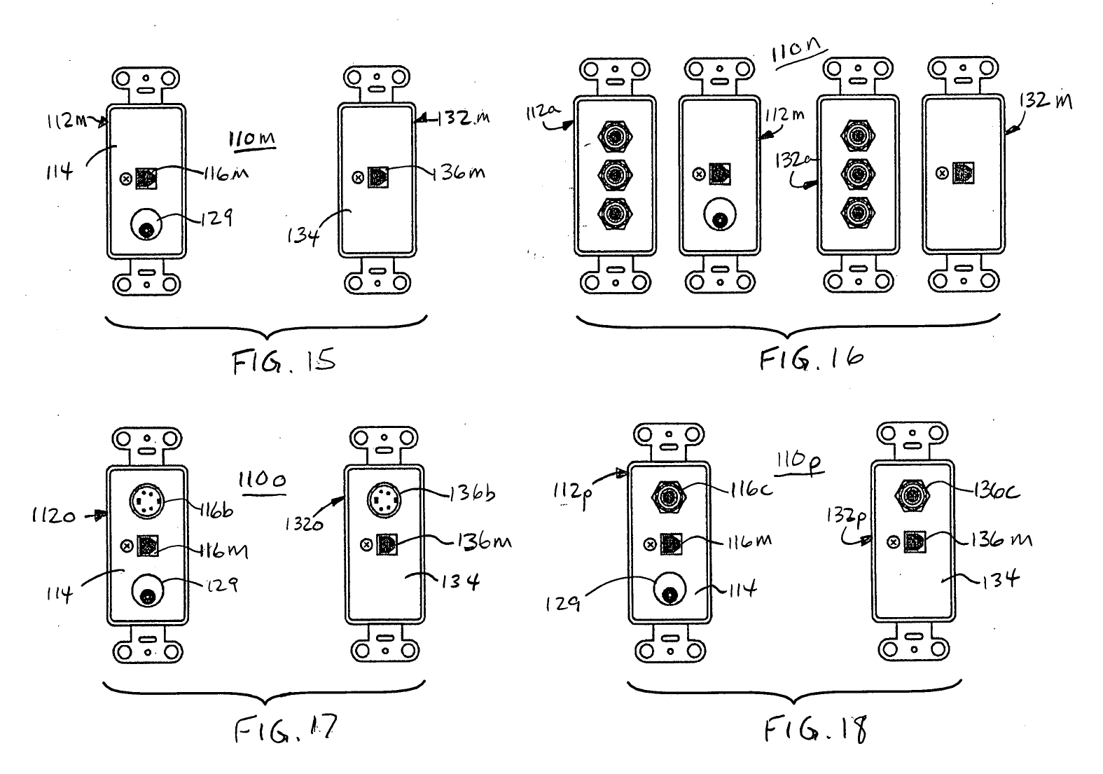

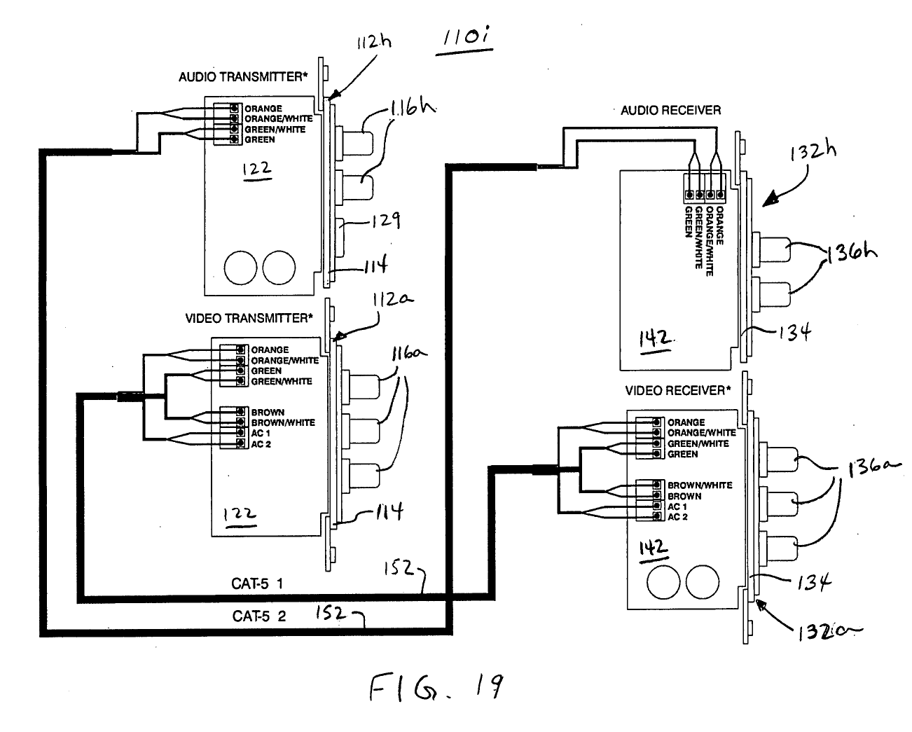

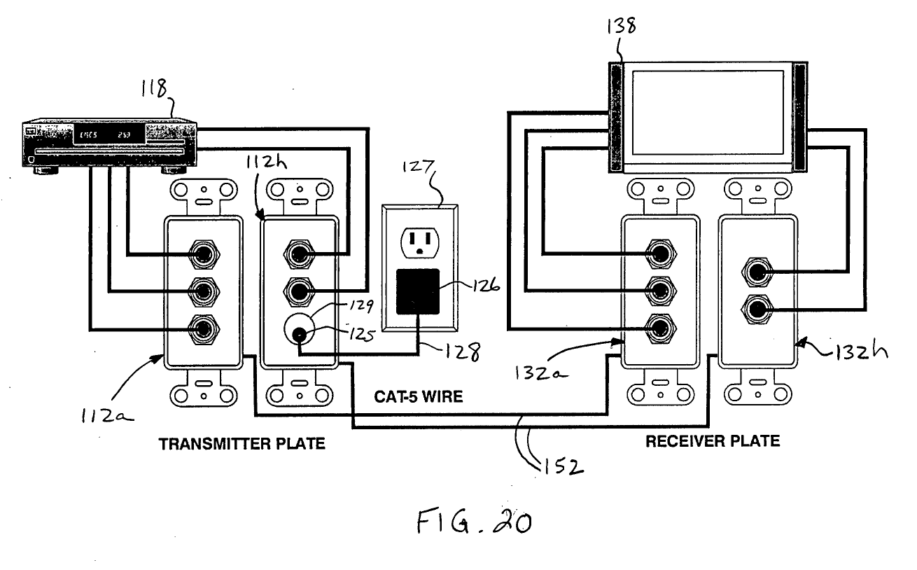

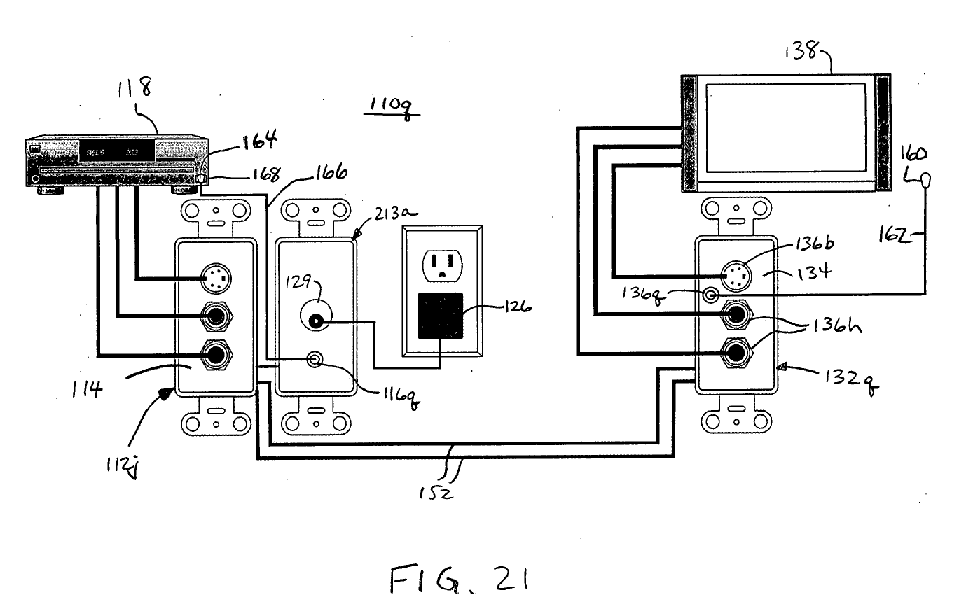

Power may be supplied to the units 112, 132 via a number of methods, several of which are illustrated in FIGS. 2A-2D. Referring now to FIGS. 2A-D (and with continued reference to FIG. 1), power from the power supply adapter 126 may be delivered over one of the twisted pairs of the cable 152 from the transmit unit 112a to the receiver unit 132a (see FIG. 2A). In an alternative embodiment, the power supply 126 may be connected to the receiver unit 132a and delivered to the unit 112a via a twisted pair of the cable 152 (see FIG. 2B). In another alternative, each of the units 112a and 132a may have a dedicated power supply 213 (see FIG. 2C). In yet another embodiment, both units may be powered over the cable 152 via a power supply 213 remotely located from both of the units 112a and 132a (see FIG. 2D). It will also be recognized that in certain embodiments an externally located power supply 126 need not used and internally wired configurations may be employed.

Referring again to FIG. 1, one or both of the circuit boards 122 and 142 may include additional signal processing circuitry, such as equalization circuitry to boost the signals or certain frequencies thereof, which may be attenuated during transmission, particularly where the run of cable 152 is relatively long. The circuitry may be user-adjustable and may include, for example, jumpers, DIP switches, or the like to provide a plurality of desired signal processing or equalization settings, e.g., to compensate for signal and/or frequency attenuation which may vary in accordance with length of the cable 152 or other factors. Other circuitry may include digital-to-analog and/or analog-to-digital converting circuitry, light responsive circuitry for generating an electrical signal in response to an incoming optical signal (e.g., wherein connector 116 is an optical connector for optical fiber or light pipe cable) and/or optical emitter circuitry for outputting an optical signal in response to an incoming electrical signal (e.g., wherein connector 136 is an optical connector for optical fiber or light pipe cable), and so forth.

Referring now to FIG. 3, there appears an exemplary embodiment 110a of the invention adapted for transmission of a component (e.g., RGB) video signal. The system 110a includes a transmitter unit 112a and a receiver unit 132a. The transmitter unit 112a includes a plate member 114 with three RCA-type phono jacks 116a. Power is supplied to the onboard amplifying and converting circuitry 124 (see FIG. 1) via an external power supply adapter 126 (see FIG. 1) which is coupled to a power supply wall plate unit 213. It will be recognized that the power supply wall plate unit may be mounted in the same electrical box as the transmitting unit 112a, the receiving unit 232a, or may be located remotely from both the units 112a and 132a.

The receiving unit 132a includes a wall plate member 134 having three RCA-type phono jacks thereon. The transmit and receive units 112a and 132a are electrically coupled via the cable 152 (see FIG. 1). Preferably, the twisted pair cable 152 (see FIG. 1) is used to electrically couple the power supply to the remotely located receive 132a although it will be recognized that any of the power distribution schemes depicted in FIGS. 2A-2D may be used.

Referring now to FIG. 4, there appears an exemplary embodiment 110b of the invention adapted for transmission of an S-Video video signal. The system 110b includes a transmitter unit 112b and a receiver unit 132b. The transmitter unit 112b includes a plate member 114 with an S-Video connector, such as a four or five conductor mini-DIN connector 116b. A power supply connector 129 is shown on the transmit unit 112b for providing power to both the transmitting and receiving units. Alternatively, the power supply connector could be placed on the receiving unit 132b, or, each of the units 112b and 136b could have its own power supply, or, a remote power supply unit 213 (see FIG. 2D) could be used to power both the transmitter 112b and receiver unit 132b. The receiving unit 132b includes a wall plate member 134 having an S-Video (e.g., mini-DIN) connector 136b thereon for outputting an S-Video signal. The transmit and receive units 112b and 132b are electrically coupled via the cable 152.

Referring now to FIG. 5, there appears an exemplary embodiment 110c of the invention adapted for transmission of a composite video signal. The system 110c includes a transmitter unit 112c and a receiver unit 132c. The transmitter unit 112c includes a plate member 114 with an RCA-type phono connector 116c. A power supply connector 129 is shown on the transmit unit 112c for providing power to both the transmit and receive units. Again, the power supply connector could alternatively be placed on the receiving unit 132c, or, each of the units 112c and 136c could have its own power supply, or, a remote power supply unit 213 (see FIG. 2D) could be used to power both the transmitter 112c and receiver unit 132c. The receiving unit 132c includes a wall plate member 134 having an RCA-type phono connector 136c thereon for outputting an analog composite video signal. The transmit and receive units 112c and 132c are electrically coupled via the cable 152.

Referring now to FIG. 6, there appears an exemplary embodiment 110d of the invention adapted for transmission of an analog composite video signal and a digital audio signal. The system 110d includes a transmitter unit 112d and a receiver unit 132d. The transmitter unit 112d includes a plate member 114 with a first RCA-type phono connector 116c for receiving a composite video signal and a second RCA-type phono connector 116d for receiving a digital audio signal. A power supply connector 129 is shown on the transmit unit 112d, but could additionally or alternatively be provided in the receive unit 132d, or, on a remote unit 213, as detailed above. The receiving unit 132d includes a wall plate member 134 having a first RCA-type phono connector 136c for outputting a composite video signal and a second RCA-type phono connector 136d for outputting a digital audio signal. The transmit and receive units 112d and 132d are electrically coupled via the cable 152.

Referring now to FIG. 7, there appears an exemplary embodiment 110e, adapted for the transmission of component video and digital audio. The system 110e combines the component video transmitter 112a and receiver 132a as described above by way of reference to FIG. 3 and the digital audio transmitter 112c and receiver 132c as described above by way of reference to FIG. 5. Where conventional CAT5 or better cabling is employed having four twisted pairs, two runs of cable 152 are required. The power supply connector is shown on the transmitter plate 112c; however, any of the power supply configurations shown in FIGS. 2A-D may be employed.

Referring now to FIG. 8, there appears an exemplary embodiment 110f of the invention adapted for transmission of a digital audio signal. The system 110f includes a transmitter unit 112f and a receiver unit 132f. The transmitter unit 112f includes a plate member 114 with an RCA-type phono connector 116f for receiving a digital audio signal. A power supply connector 129 is shown on the transmit unit 112f for providing power to both the transmit and receive units. It will be recognized that any of the power distribution schemes depicted in FIGS. 2A-D could be used. The receiving unit 132f includes a wall plate member 134 having an RCA-type phono connector 136f for outputting a digital audio signal. The transmit and receive units 112f and 132f are electrically coupled via the cable 152.

Referring now to FIG. 9, there appears an exemplary embodiment 110g of the invention adapted for transmission of an S-Video video signal and a digital audio signal. The system 110g includes a transmitter unit 112g and a receiver unit 132g. The transmitter unit 112g includes a plate member 114 with an S-Video connector, such as a mini-DIN connector 116b and an RCA-type phono connector 116f for receiving a digital audio signal. A power supply connector 129 is shown on the transmit unit 112g for providing power to both the transmit and receive units. It will be recognized that any of the power distribution schemes depicted in FIGS. 2A-D could be used. The receiving unit 132g includes a wall plate member 134 having an S-Video (e.g., mini-DIN) connector 136b thereon for outputting an S-Video signal and an RCA-type phono connector 136f for outputting a digital audio signal. The transmit and receive units 112g and 132g are electrically coupled via the cable 152.

Referring now to FIG. 10, there appears an exemplary embodiment 110h of the invention adapted for transmission of an analog stereo (e.g., left and right channels) audio signal. The system 110h includes a transmitter unit 112h and a receiver unit 132h. The transmitter unit 112h includes a plate member 114 with a pair of RCA-type phono connectors 116h for receiving a stereo audio signal pair. A power supply connector 129 is shown on the transmit unit 112h for providing power to both the transmit and receive units. It will be recognized that any of the power distribution schemes depicted in FIGS. 2A-D could be used. The receiving unit 132h includes a wall plate member 134 having a pair of RCA-type phono connectors 136h for outputting a stereo audio signal pair. The transmit and receive units 112h and 132h are electrically coupled via the cable 152.

Referring now to FIG. 11, there appears an exemplary embodiment 110i, adapted for the transmission of component video and analog (e.g., stereo) audio. The system 110i combines the component video transmitter 112a and receiver 132a as described above by way of reference to FIG. 3 and the analog audio transmitter 112h and receiver 132h as described above by way of reference to FIG. 10. Where conventional CAT5 or better cabling is employed having four twisted pairs, two runs of cable 152 are required. The power supply connector is shown on the transmitter plate 112h; however, any of the power supply configurations shown in FIGS. 2A-D may be employed. A side view of the system shown in FIG. 11 appears in FIG. 19. An exemplary audio/video configuration employing the system of FIG. 11 appears in FIG. 20.

Referring now to FIG. 12, there appears an exemplary embodiment 110j of the invention adapted for transmission of an S-Video video signal and an analog audio (e.g., stereo) signal. The system 110j includes a transmitter unit 112j and a receiver unit 132j. The transmitter unit 112j includes a plate member 114 with an S-Video connector, such as a mini-DIN connector 116b and a pair of RCA-type phono connector 116h for receiving an analog audio signal (e.g., a stereo pair). A power supply unit 213 having a connector 129 is shown and may be used to supply power to the transmit and receive units in accordance with any of the schemes depicted in FIGS. 2A-D. The receiving unit 132j includes a wall plate member 134 having an S-Video (e.g., mini-DIN) connector 136b thereon for outputting an S-Video signal and a pair of RCA-type phono connectors 136h for outputting an analog audio signal (e.g., stereo pair). The transmit and receive units 112j and 132j are electrically coupled via the cable 152. For a cable 152 having four twisted pairs, two runs of the cable 152 are required for this embodiment.

Referring now to FIG. 13, there appears an exemplary embodiment 110k of the invention adapted for transmission of an analog composite video signal and an analog (e.g., stereo) audio signal. The system 110k includes a transmitter unit 112k and a receiver unit 132k. The transmitter unit 112k includes a plate member 114 with a first RCA-type phono connector 116c for receiving a composite video signal and a pair of RCA-type phono connectors 116h for receiving an analog (e.g., stereo) audio signal. A power supply unit 213 having a connector 129 is shown and may be used to supply power to the transmit and receive units in accordance with any of the schemes depicted in FIGS. 2A-D. The receiving unit 132k includes a wall plate member 134 having a first RCA-type phono connector 136c for outputting a composite video signal and a pair of RCA-type phono connectors 136h for outputting an analog audio (stereo) signal. The transmit and receive units 112k and 132k are electrically coupled via the cable 152.

Referring now to FIG. 14, there appears an exemplary embodiment 110l of the invention adapted for transmission of an analog stereo audio signal. The system 110l includes a transmitter unit 112l and a receiver unit 132h. The transmitter unit 112l includes a plate member 114 with a stereo phone-type connector 116l (such as a ⅛-inch stereo jack) for receiving an analog audio signal, e.g., from a line out or headphone out from a portable media player. A pair of RCA-type phono connectors 116h for receiving a stereo audio signal pair may also be provided. The connector 116l and the connector pair 116h are preferably designed for use in the alternative and may share the same twisted pairs of the cable 152. In this manner, the connectors 116h may be used with a ⅛-inch stereo phone type cable, RCA-type phono cable, or a ⅛-inch stereo to RCA “Y” type cable. A power supply connector 129 is shown on the transmit unit 112l for providing power to both the transmit and receive units. It will be recognized that any of the power distribution schemes depicted in FIGS. 2A-D could be used. The receiving unit 132h includes a wall plate member 134 having a pair of RCA-type phono connectors 136h for outputting a stereo audio signal pair. The transmit and receive units 112l and 132h are electrically coupled via the cable 152.

Referring now to FIG. 15, there appears an exemplary embodiment 110m of the invention adapted for transmission of a optical audio signal. The system 110m includes a transmitter unit 112m and a receiver unit 132m. The transmitter unit 112m includes a plate member 114 with optical connector (e.g., a TOSLINK or other type) 116m for receiving an optical digital (e.g., S/PDIF) audio signal. A power supply connector 129 is shown on the transmit unit 112m for providing power to both the transmit and receive units. It will be recognized that any of the power distribution schemes depicted in FIGS. 2A-D could be used. The receiving unit 132m includes a wall plate member 134 having a TOSLINK or other type of optical connector 136m for outputting an optical audio signal. The optical signal is converted to an electrical signal for transmission over the cable 152 by the transmitting unit 112m. The electrical signal received over the cable 152 is converted to an optical signal by the receiving unit 132m.

It will be recognized that the output connector(s) need not be the same as the input connector(s) and the transmission system may provide the appropriate conversion therefore. By way of non-limiting example, an unbalanced signal from the source audio/video equipment may be output to the receiving audio/video equipment as a balanced signal, and vice versa; a digital signal from the source audio/video equipment may be output to the receiving audio/video equipment as an analog signal, and vice versa; an optical (e.g., light pipe) signal from the source audio/video equipment may be output to the receiving audio/video equipment as a cabled S/PDIF (e.g., using a coaxial RCA type connector) or analog signal, and vice versa; and so forth.

Referring now to FIG. 16, there appears an exemplary embodiment 110n, adapted for the transmission of component video and optical audio. The system 110n combines the component video transmitter 112a and receiver 132a as described above by way of reference to FIG. 3 and the optical audio transmitter 112m and receiver 132m as described above by way of reference to FIG. 15. For a cable 152 having four twisted pairs, two runs of the cable 152 are required for this embodiment. The power supply connector is shown on the transmitter plate 112m, however, any of the power supply configurations shown in FIGS. 2A-D may be employed.

Referring now to FIG. 17, there appears an exemplary embodiment 110o of the invention adapted for transmission of an S-Video video signal and an optical audio signal. The system 110o includes a transmitter unit 112o and a receiver unit 132o. The transmitter unit 112o includes a plate member 114 with an S-Video connector, such as a mini-DIN connector 116b and an optical connector 116m for receiving an optical audio signal. A power supply connector 129 is shown on the transmit unit 112o for providing power to both the transmit and receive units. It will be recognized that any of the power distribution schemes depicted in FIGS. 2A-D could be used. The receiving unit 132o includes a wall plate member 134 having an S-Video (e.g., mini-DIN) connector 136b thereon for outputting an S-Video signal and an optical connector 136m for outputting an optical audio signal. The optical signal is converted to an electrical signal for transmission over the cable 152 by the transmitting unit 112o and converted back into an optical signal by the receiving unit 132o.

Referring now to FIG. 18, there appears an exemplary embodiment 110p of the invention adapted for transmission of a composite video signal and an optical audio signal. The system 110p includes a transmitter unit 112p and a receiver unit 132p. The transmitter unit 112p includes a plate member 114 with a composite video connector 116c and an optical connector 116m for receiving an optical audio signal. A power supply connector 129 is shown on the transmit unit 112p for providing power to both the transmit and receive units. It will be recognized that any of the power distribution schemes depicted in FIGS. 2A-D could be used. The receiving unit 132p includes a wall plate member 134 having a composite video connector 136c thereon for outputting a composite video signal and an optical connector 136m for outputting an optical audio signal. The optical signal is converted to an electrical signal for transmission over the cable 152 by the transmitting unit 112p and converted back into an optical signal by the receiving unit 132p.

Referring now to FIG. 21, there appears an exemplary transmission embodiment 110q including an integral optical repeater system for remotely controlling an audio/video source 118. The optical repeater is preferably an infrared (IR) repeater. The depicted embodiment 110q includes a transmitter unit 112j and a receiver unit 132q. The transmitter unit 112j is as described above by way of reference to FIG. 12. A power supply wall plate unit 213a includes a connector 129 for connection to an adapter 126. The unit 213a is adjacent the unit 112j and additionally includes a connector 116q (e.g., a ⅛-inch phone plug jack) for connecting an optical emitter (e.g., an LED) 164, which is adapted to be mounted in optical communication with an optical sensor 168 on the audio/video source equipment 118. The emitter 164 is electrically coupled to the connector 116q via a length of cable 166 terminating in an appropriate connector (e.g., ⅛-inch phone plug). Alternatively, the connector 116q could be located on the plate member 114 of the unit 112j or dedicated wall plate unit, in which case the power supply wall plate unit could be positioned in accordance with any of the power distribution schemes depicted in FIGS. 2A-D.

The receiving unit 132q includes a wall plate member 134 having an S-Video connector 136b thereon for outputting an S-Video signal, a pair of RCA-type phono connectors 136h for outputting an analog audio signal, and a connector 136q (e.g., a ⅛-inch phone plug jack) for connecting an optical sensor 160. For conventional twisted pair cabling having four twisted pairs, two runs of the cable 152 are required.

The optical sensor 160 is electrically coupled to the connector 136q via a length of cable 162 terminating in an appropriate connector (e.g., ⅛-inch phone plug) and may be mounted or positioned near the receiving audio/video equipment. The optical sensor provides an optical target for use with a hand-held (e.g., IR) remote control unit for controlling the source equipment 118. The sensor 160 generates an electrical signal in response a received optical signal, which is transmitted to the emitter 164 via driving circuitry, e.g., on the wall plate unit 132q, over the twisted pair cable 152. It will be recognized that the embodiment of FIG. 21 is exemplary only and that the optical repeater system may be employed in conjunction with other wall plate units having all manner of audio/video connector types and combinations, including audio only connectors, video connectors, and audio and video connectors.

The invention has been described with reference to the preferred embodiments. Obviously, modifications and alterations will occur to others upon reading and understanding the preceding detailed description. It is intended that the invention be construed as including all such modifications and alterations insofar as they come within the scope of the appended claims or the equivalents thereof.

Having thus described the preferred embodiments, the invention is now claimed to be:

1. A system for distributing an audio/video signal from an audio/video source to an audio/video receiver, comprising:
a transmitter assembly including a first wall plate, a source audio/video connector adapted to be coupled to an output of the audio/video source, and a first circuit board attached to said first wall plate;
said first circuit board including a first signal processor in communication with said source audio/video connector and a first plurality of terminals in communication with said first signal processor;
a receiver assembly including a second wall plate, a receiver audio/video connector adapted to be coupled to the audio/video receiver, and a second circuit board attached to said second wall plate;
said second circuit board including a second signal processor in communication with said receiver audio/video connector and a second plurality of terminals in communication with said second signal processor; and
a twisted pair cable having a first end and a second end and including one or more twisted pairs of conductors, wherein each terminal of the first plurality of terminals is adapted to be connected to an individual conductor of said one or more twisted pairs of conductors at the first end of said cable and wherein each terminal of the second plurality of terminals is adapted to be connected to an individual conductor of said one or more twisted pairs of conductors at the second end of said cable.

2. The system of claim 1, wherein each of said transmitter assembly and said receiver assembly are adapted to be attached to an electrical wall box.

3. The system of claim 1, wherein said first signal processor comprises an amplifier.

4. The system of claim 1, wherein said first signal processor comprises a differential amplifier for converting an unbalanced audio/video signal to a balanced audio/video signal.

5. The system of claim 1, wherein said second signal processor comprises one or both of an amplifier and an audio/video transformer.

6. The system of claim 1, wherein said second signal processor comprises a differential amplifier for converting an balanced audio/video signal to a unbalanced audio/video signal.

7. The system of claim 5, wherein said second signal processor includes equalization circuitry.

8. The system of claim 7, wherein said equalization circuitry is adjustable.

9. The system of claim 8, wherein said equalization circuitry includes multiple settings, wherein each setting compensates for an estimated signal attenuation, the estimated signal attenuation based on a length of said twisted pair cable.

10. The system of claim 1, wherein said twisted pair cable is an unshielded twisted pair cable.

11. The system of claim 10, wherein said twisted pair cable is selected from Category 5, Category 5e, and Category 6 twisted pair cable.

12. The system of claim 1, wherein said source audio/video connector and said receiver audio/video connector, which may be the same or different, are selected from the group consisting of one or more analog audio connectors, one or more digital audio connectors, one or more analog video connectors, one or more digital video connectors, and any combination thereof.

13. The system of claim 12, wherein said source and receiver audio/video connectors, which may be the same or different, are selected from the group consisting of phone plug jacks, RCA-type phono connectors, S-Video connectors, mini-DIN connectors, and optical connectors, and any combination thereof.

14. The system of claim 1, further comprising:
a power supply connector for connecting a power supply to one or both of said first signal processor and said second signal processor.

15. The system of claim 14, further comprising:
said power supply electrically coupled to one or both of said first signal processor and said second signal processor via said twisted pair cable.

16. The system of claim 1, further comprising an optical repeater system, said optical repeater system including:
an optical receiver for receiving an incoming optical signal and converting it to an electrical signal representative of the optical signal;
a optical transmitter for receiving the electrical signal representative of the incoming optical signal and generating an output IR signal;
said optical receiver being electrically coupled to said optical transmitter via a twisted conductor pair of said twisted pair cable.

17. The system of claim 16, further comprising:
an IR sensor electrically coupled to said optical receiver; and
an IR emitter including an IR light source electrically coupled to said optical transmitter.

18. A method for distributing an audio/video signal from an audio/video source to an audio/video receiver, comprising:
operating the audio/video source to generate an audio/video signal to be transmitted;
connecting the output of an audio/video source to a wall-mounted transmitter assembly, said transmitter assembly including a source audio/video connector, a wall plate connected to a electrical wall box, and a first circuit board received within the electrical wall box, said first circuit board including a first signal processor in communication with said source audio/video connector and a first plurality of terminals in communication with said first signal processor;
connecting the input of an audio/video receiver to a wall-mounted receiver assembly, said receiver assembly including a receiver audio/video connector, a wall plate attached to an electrical wall box, and a second circuit board attached to the wall plate, said second circuit board including a second signal processor in communication with said receiver audio/video connector and a second plurality of terminals in communication with said second signal processor; and
connecting a first conductor to one of said first plurality of terminals and to one of said second plurality of terminals, and connecting a second conductor to another of said first plurality of terminals and to another of said second plurality of terminals, the first and second conductors being individual conductors of a twisted pair of conductors of a twisted pair cable extending between the wall plate transmitter and the wall plate receiver.

19. A kit having component parts capable of being packaged in a disassembled or partially disassembled form and of being assembled into a system adapted for distributing an audio/video signal from an audio/video source to an audio/video receiver, said kit comprising:
a transmitter assembly including a first wall plate, a source audio/video connector adapted to be coupled to an output of the audio/video source, and a first circuit board attached to said first wall plate;
said first circuit board including a first signal processor in communication with said source audio/video connector and a first plurality of terminals in communication with said first signal processor;
a receiver assembly including a second wall plate, a receiver audio/video connector adapted to be coupled to the audio/video receiver, and a second circuit board attached to said second wall plate;
said second circuit board including a second signal processor in communication with said receiver audio/video connector and a second plurality of terminals in communication with said second signal processor;
each terminal of said first and second plurality of terminals being adapted to connect an individual conductor of a twisted pair cable.
